(19) United States
(12) Patent Application Publication
(10) Pub. No.: US 2020/0410521 A1
(43) Pub. Date: Dec. 31, 2020

(54) SYSTEM TO DISTINGUISH HUMAN INPUT FROM MACHINE INPUT ON A VIDEO DELIVERY WEBSITE PRIOR TO AWARDING CLICK-PER-VIEW-REWARDS

(71) Applicant: Christopher D. WONG, Victoria (CA)

(72) Inventor: Christopher D. WONG, Victoria (CA)

(21) Appl. No.: 16/910,180

(22) Filed: Jun. 24, 2020

(30) Foreign Application Priority Data
Jun. 25, 2019 (CA) 3048037

(51) Int. Cl. G06Q 30/02; G06Q 30/00; G06F 16/738; H04L 29/06; H04L 29/12

(52) U.S. Cl. CPC G06Q 30/0225; G06Q 30/0236; G06Q 30/0203; G06Q 30/0185; H04L 61/6022; H04L 63/1441; H04L 61/20; H04L 2463/144; G06F 16/738

(57) ABSTRACT

A system to distinguish human input from machine input on a video delivery website prior to awarding click-per-view rewards. A question set must be completed in order to claim click-per-view rewards. The server records each unique registered user and each unique Media Access Control (MAC) address for each device and denies access to the question set from registered user or a device that has previously accessed the question set for the selected video presentation, thereby preventing multiple access to the question set of the selected video presentation by the same device. The server tracks combinations of questions that have been used from the first question pool database and the second question pool database, to ensure that identical combinations of questions are never duplicated. The server validates input through the user input portal as being human input and awards click-per-view rewards only if correct answers have been given to all of the questions in the question set.

A system to distinguish human input from machine input on a video delivery website prior to awarding click-per-view rewards

### FIELD

There is described a system to distinguish human input from machine input on a video delivery website in order to defeat persons using web-crawler bots to improperly collect click-per-view rewards.

### BACKGROUND

U.S. Patent publication 2018/0047050 (Wong) titled “Method of Automated Computer Screening of Clicks with Pay-Per-Click Advertising” discloses the use of random sets of questions as a security measure to defeat web-crawler bots. The Wong application describes the problems associated with trying to differentiate human input from machine input, as the artificial intelligence of web-crawler bots improves.

The Wong publication describes pay-per-click advertising in which consumers are paid to watch video advertisements. The concept of Wong was to ask randomly generated questions on the content of the video. However, there is a limit to the number of questions one can possibly ask relating specifically to the content of a video. It must be appreciated the web-crawler bots can interact with a website thousands of times. It was determined that repeated interactions by web-crawler bots with a web site using questions, will eventually result in an answer key of the correct answers being developed by the web-crawler bots from trial and error interactions.

### SUMMARY

There is provided a system to distinguish human input from machine input on a video delivery website prior to awarding click-per-view rewards. The system includes a server connected to a world wide web and a video database containing one or more video presentations. A user input portal is provided through which a user accesses via the server a selected video presentation of the video presentations in the video database and registers to become a registered user to receive click-per-view rewards. A first question pool database accessible by the server, the first question pool database containing a pool of questions specifically relating to the selected video presentation. A second question pool database is provided accessible by the server, the second question pool database containing a pool of supplementary questions not relating to the selected video presentation. The server being programmed to create a question set of at least three questions comprising some questions selected from the first question pool database and at least one question selected from the second question pool database.

In operation, the server records each unique registered user who accesses the question set for the selected video presentation. The server is programmed to deny access to the question set of the selected video from a registered user that has previously accessed the question set for the selected video presentation, thereby preventing multiple access to the question set of the selected video presentation by the same registered user.

In operation, the server records a unique Media Access Control (MAC) address for each device that accesses the question set for the selected video presentation. The server is programmed to deny access to the question set of the selected video from a device that has previously accessed the question set for the selected video presentation, thereby preventing multiple access to the question set of the selected video presentation by the same device masquerading as a different registered user.

In operation, the server is programmed to track combinations of questions that have been used from the first question pool database and the second question pool database, excluding at least one question from the first question pool for each subsequent question set and excluding from each subsequent question set questions that have already been used from the second question pool database, such that identical combinations of questions are never duplicated.

In operation, the server being programmed to validate input through the user input portal as being human input and award click-per-view rewards only if correct answers have been given to all of the questions in the question set.

The system functions with at least three question. However, as will hereinafter be described, as more questions are added to the question set, security against web-crawler bot attack improves. It is preferred that six or more questions be used to achieve the highest level of security.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic diagram of the system.

FIG. 2 is a logic flow diagram of the system of FIG. 1.

FIG. 3 is a process step diagram of the system of FIG. 1.

FIG. 4 is a schematic diagram of the question pool of FIG. 1.

### DETAILED DESCRIPTION

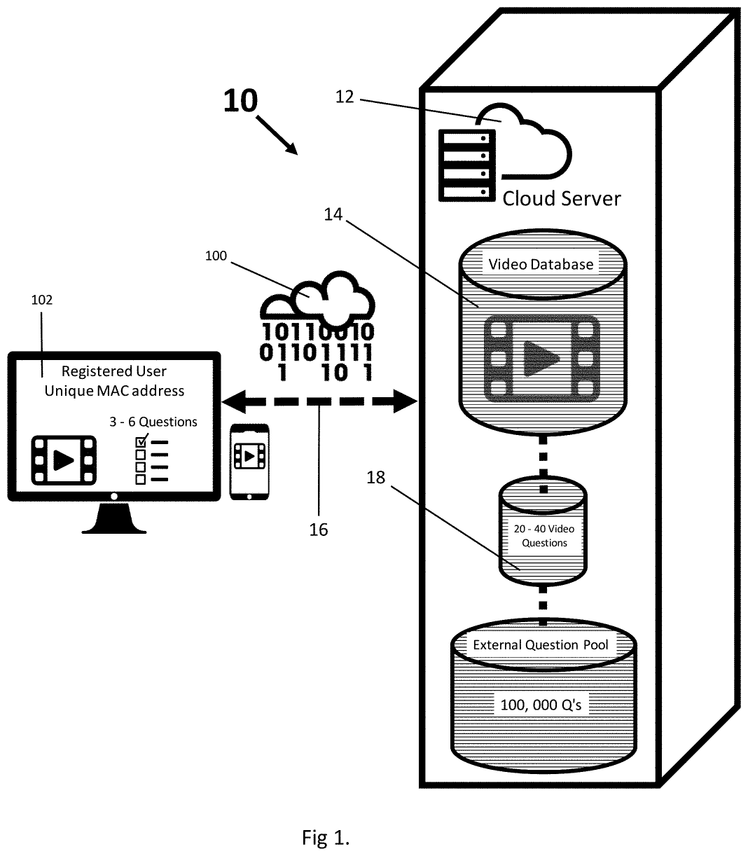

A system to distinguish human input from machine input on a video delivery website, generally identified by reference numeral 10, will now be described with reference to FIG. 1 through FIG. 4.

### Structure and Relationship of Parts:

Referring to FIG. 1, system 10 includes a server 12 connected to the World Wide Web 100. A video database is provided containing one or more video presentations 14. A user input portal 16 is provided through which a user computers 102 or device connected through world wide web 100 accesses, via server 12, a selected video presentation of the video presentations in the video database 14 and registers to become a registered user in order to receive click-per-view rewards. A first question pool database 18 is provided and accessible by server 12 containing a pool of questions specifically relating to video presentation 14. It has been found that first question pool database usually contains 20-40 questions. A second question pool database 20 is provided accessible by server 12 containing a pool of supplementary questions not relating to video presentation 14. The question pool developed for implementation has approximately 100,000 questions on a variety of topics.

### Operation:

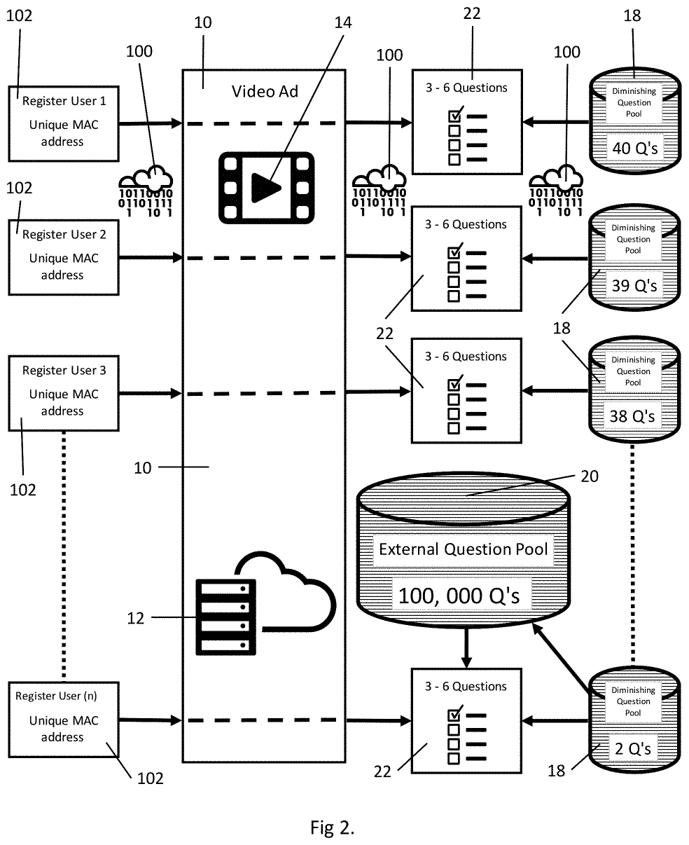

In order to claim rewards for watching a video, a user must register and become a “registered user”. With a legitimate registered user, this registration is intended to identify the registered user and provide contact particulars that enable click-per-view rewards to be allocated. Referring to FIG. 2 through FIG. 4, when a registered user seeks to claim click-per-view rewards, server 12 is programmed to create a question set 22 of six questions, as will hereinafter be described.

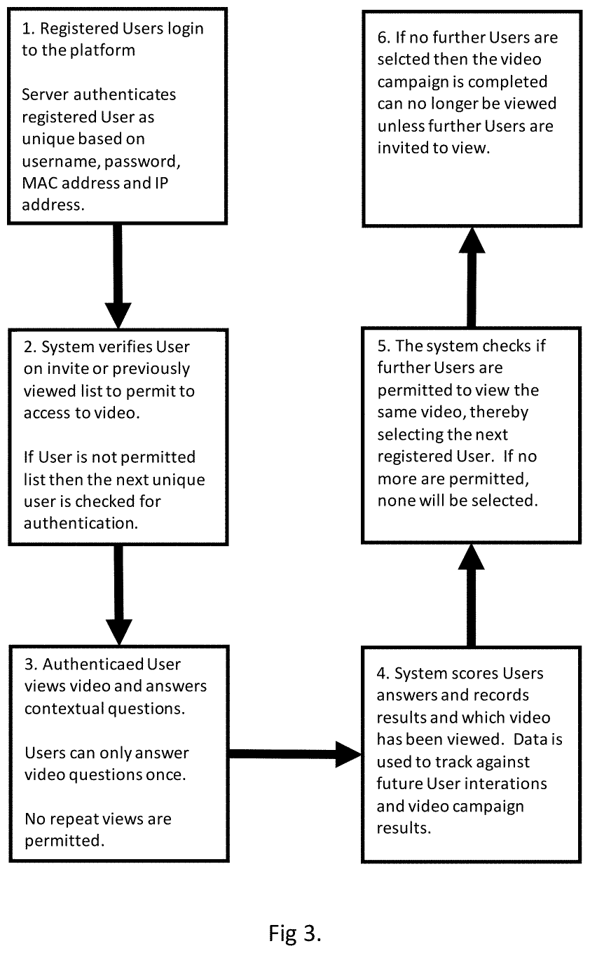

Referring to FIG. 2 and FIG. 3, server 12 records a registered user which a request to access question set 22 originates. Server 12 is programmed to deny access to question set 22 when a previous request has originated from the same registered user. The purpose of this screening is to prevent multiple requests for access to question set 22 by the same registered user. There is no legitimate reason why the same registered user would want to claim click-per-view rewards for watching the selected video a second time. Multiple requests from the same registered user to access question set 22 for the selected view is interpreted by server 12 as a web-crawler bot attack.

Referring to FIG. 2 and FIG. 3, server 12 also records a unique Media Access Control (MAC) address of each computer 102 or device from which a request to access question set 22 originates. Server 12 is programmed to deny access to question set 22 when a previous request has originated from the same unique MAC address. The purpose of this screening is to prevent multiple requests for access to the question set 22 by a computer 102 or device with the same unique MAC address masquerading as a different registered user. Multiple requests from the same a computer 102 or device with the same unique MAC address is interpreted by server 12 as a web-crawler bot attack.

Referring to FIG. 2 through FIG. 4, if the same registered user or the unique MAC address has not accessed the website previously, server 12 allows access to question set 22 of six questions. This question set 22 consists of some questions relating to video content randomly selected from first question pool database 18 and at least one question unrelated to the video content selected from second question pool database 20. The implementation which is preferred consists of five questions from first question pool database 18 and one question from second question pool database 20. This is arbitrary, as there could just as easily be four questions from first question pool database 18 and two questions from second question pool database 20.

Server 12 is programmed to validate input through user input portal 16 as being human input only if correct answers have been given to all of the questions in question set 22, as a precondition to the issue of click-per-view rewards.

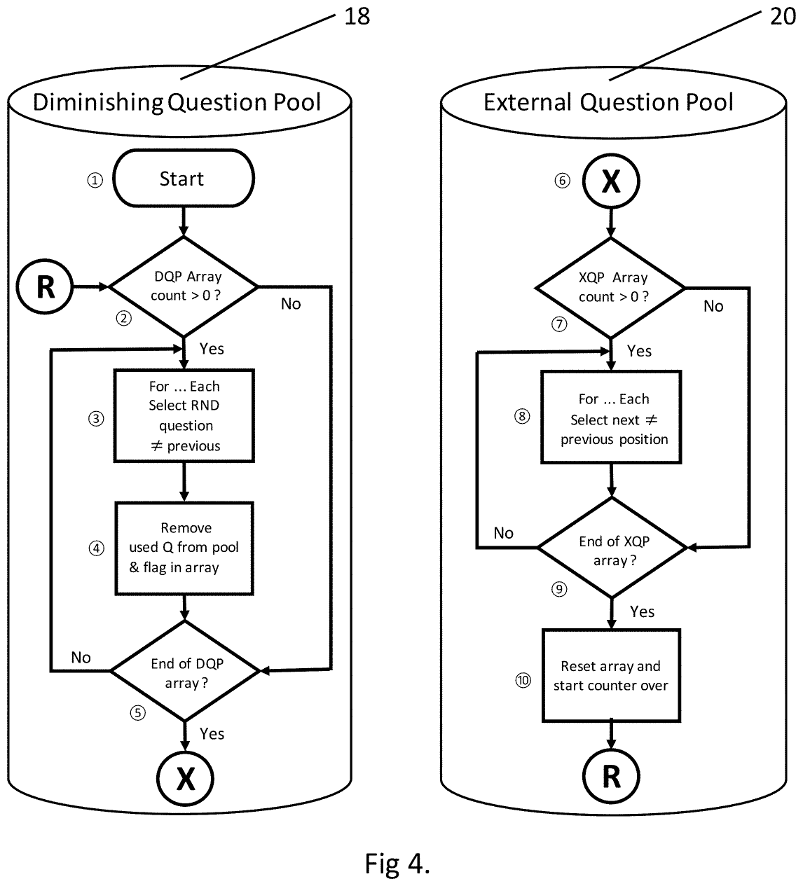

Referring to FIG. 4, server 12 is programmed to track combinations of questions that have been used from the first question pool database 18 and the second question pool database 20. Server 12 excludes at least one question from the first question pool for each subsequent question set. As first question pool database is limited in size, the exclusion of questions means that server 12 is drawing from a diminishing pool of questions. Once the pool of questions from first question pool database 18 has been exhausted there is no choice but to start reusing the question. This would normally mean that web-crawler bots, through numerous attacks would have a chance of developing an answer key. However, question set is also made up of questions from second question pool database 20. In view of the fact that this question pool has questions on a variety of topics in it, there is no size limit and the database can contain 100,000 questions or more. Those questions are also constantly changing, as server 12 excludes from each subsequent question set questions that have already been used from the second question pool database. This combination of diminishing pools ensures that combinations of questions are never duplicated, even though the questions in first question pool database 18 will periodically have to be repeated.

It will now be further explained why this system deprives web-crawler bots from having an opportunity to learn and develop an answer key.

A first level of defence is preventing the same Registered User or a device with the same MAC address from accessing the same question set. If the device cannot access the same question set, it cannot try to develop an answer key to fraudulently claim click-per-view rewards.

A second level of defence is to require all questions in a question set consisting of multiple questions to be answered correctly. While the system will provide some security with as few as three questions, it is believed that in order to give the highest level of security, the question set should have at least six questions. Based upon random selection, a web-crawler has a 16% chance of correctly answering one question out of six. A web-crawler has only a 2.7% chance of correctly answering two questions out of six. A web-crawler has only a 0.44% chance of correctly answering three question out of six. While 0.44% represents reasonable security, as additional questions are added, the odds become substantially lower. A web-crawler has only a 0.002% chance of correctly answering six questions out of six. This is the reason what six questions or more are preferred.

A third level of defence is changing the list of questions for each user. Artificial intelligence requires feedback in order to “learn”. The system gives no user feedback as to which questions in the question set were answered correctly and which questions in the question set were answered incorrectly. There is, therefore, no basis upon which the web-crawler bots can learn. In order to create an answer key, they must answer all six questions correctly. As stated above, the web-crawler has a 0.002% chance of answering six questions out of six. Even if the web-crawler gets the six questions correctly, the chance of that random selection being duplicated does not exist, as the question set will constantly change. The system changes the combination of questions drawn from first question database pool 18 and excludes the question or question which was used from second question pool database 20 each time so the web-crawler bot never has same question set to answer on a subsequent attack. A “successful” attack by a web-crawler bot will, therefore, not lead to further successful attacks.

Referring to FIG. 4, a further explanation of the logic behind the generation of the question set appears below:

\textcircled{1} Start the Diminishing Pool Question order routine (DQP)

\textcircled{2} If the question order array is greater than zero then go to step \textcircled{3} If the question order array is equal to zero then go to step \textcircled{5}

\textcircled{3} Select a random question from the pool and check that it does not appear in the same position in the array which determines the set order

\textcircled{4} remove one of the used questions from either pool and record the removed question into the array to track for reference and comparison.

\textcircled{5} If we have not reached the end of the array, go to step \textcircled{3} If we have reached the end then go the External Question Pool (X)

\textcircled{6} Start the External Question Pool routine (XQP)

\textcircled{7} If the question order array is greater than zero then go to step \textcircled{8} If the question order array is equal to zero then go to step \textcircled{9}

\textcircled{8} Select next question from the pool and check that this combination has not appeared in any question set

\textcircled{9} If the combination has previously appeared then, go to step \textcircled{8} If the combination has not then go to the next process \textcircled{10}

\textcircled{10} Reset the array to the beginning and return to the initial Diminishing Question Pool routine (R)

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A system to distinguish human input from machine input on a video delivery website prior to awarding click-per-view rewards, comprising:
a server connected to a world wide web;
a video database containing one or more video presentations;
a user input portal through which a user accesses via the server a selected video presentation of the video presentations in the video database and registers to become a registered user in order to receive click-per-view rewards;
a first question pool database accessible by the server, the first question pool database containing a pool of questions specifically relating to the selected video presentation;
a second question pool database accessible by the server, the second question pool database containing a pool of supplementary questions not relating to the selected video presentation;
the server being programmed to create a question set of at least three questions comprising some questions selected from the first question pool database and at least one question selected from the second question pool database;
the server records each unique registered user that accesses the question set for the selected video presentation, the server being programmed to deny access to the question set of the selected video from a registered user that has previously accessed the question set for the selected video presentation, thereby preventing multiple access to the question set of the selected video presentation by the same registered user;
the server records a unique Media Access Control (MAC) address for each device that accesses the question set for the selected video presentation, the server being programmed to deny access to the question set of the selected video from a device that has previously accessed the question set for the selected video presentation, thereby preventing multiple access to the question set of the selected video presentation by the same device, masquerading as a different registered user;
the server being programmed to track combinations of questions that have been used from the first question pool database and the second question pool database, excluding at least one question from the first question pool for each subsequent question set and excluding from each subsequent question set questions that have already been used from the second question pool database, such that identical combinations of questions are never duplicated; and
the server being programmed to validate input through the user input portal as being human input and award click-per-view rewards only if correct answers have been given to all of the questions in the question set, and denying click-per-view rewards if any question in the question set is incorrectly answered.

2. The system of claim 1, wherein the question set has at least six questions.
